(19) United States
(12) Patent Application Publication
(10) Pub. No.: US 2010/0212312 A1
(43) Pub. Date: Aug. 26, 2010

(54) Stacked Morphing Actuator

(76) Inventor: Dickory Rudduck, (US)

Correspondence Address: TELEZYGOLOGY, INC., 520 W. ERIE STREET, SUITE 210, CHICAGO, IL, 60654, US

(21) Appl. No.: 12/664,857

(22) PCT Filed: Jun. 16, 2008
(86) PCT No.: PCT/US08/67073

§ 371 Date: Dec. 15, 2009

Related U.S. Application Data
(60) Provisional application No. 60/944,301, filed on Jun. 15, 2007.

(51) Int. Cl. F03G 7/06

(52) U.S. Cl. 60/527

(57) ABSTRACT

This invention relates to a stacked, bending actuator 2 comprising at least two leaves 8 having bending or morphing capabilities, material adapted to contract when activated 6 attached to said leaves S; and electronic control IO wherein said leaves 8 and said material adapted contract when activated 6 are stacked in a desired arrangement. This arrangement allows an actuator to have bending capabilities for amplifying linear or rotational movement.

### FIELD OF THE INVENTION

This invention relates to actuators. More specifically, this invention relates to a bending actuator with bending capabilities for amplifying linear or rotational movement.

### BACKGROUND OF THE INVENTION

Actuators utilizing smart materials have been gaining popularity over recent years. There is an extremely wide range of applications for such actuators, ranging from those found in computer components and electronics to fasteners and secure enclosures found on an aircraft or automobile. While the uses of smart materials in actuators are seemingly endless, there are sonic drawbacks. Smart materials tend to have a limited useful lifespan, may be prone to breakage, and can only contract consistently about 3%. Therefore there is a demand to improve the lifespan on the material and to amplify the movement achieved by contraction.

This invention provides such a solution in that the bending, stacked actuator amplifies movement linearly, rotationally, and in three dimensions.

### SUMMARY OF THE INVENTION

Accordingly, this invention relates to a stacked, bending actuator comprising:
at least two leaves having bending or morphing capabilities,
material adapted to contract when activated attached to said leaves; and
electronic control
   wherein said leaves and said material adapted contract when activated are stacked in a desired arrangement.

In most embodiments, this stacked, bending actuator will comprise more then two leaves and strands or sheets of material adapted to contract when activated. This material adapted to contract when activated is preferably shape memory alloy (SMA) wire or strips. Shape memory alloys are known and are usually made predominantly or wholly of titanium and nickel. They may also include other material, such as aluminium, zinc and copper. A shape memory alloy is capable of adopting one shape below a predetermined transition temperature and changing to a second shape once its temperature exceeds the transition temperature. Conversely, when the shape memory alloy cools below the transition temperature, it is capable of adopting the first shape again. In connection with the various aspects of the present invention, the shape memory alloy contracts when heated in situ. Shape memory alloy wire currently available, such as that sold under the trade mark Nitinol, is capable of contracting by about 3% when activated by heating.

Activation of the material adapted to contract when activated is preferably achieved through electrical resistance heating, with a wire feed to the assembly. Activation of the shape memory alloy wire can be initiated from a central location, using the wiring system of, for example, a security system. It is also within the scope of this invention that the activation is initiated by remote means, such as a hand held tool operating through the use of any suitable form of energy, including microwave, electric magnetic, sonic, infra-red, radio frequency and so on.

The scope of the invention in its various aspects is not necessarily limited to the use of shape memory alloy. Other material may also be useful. Also, while activation may take place through heating, other means of activation may be suitable and are within the scope of this invention.

The leaves of this invention are stacked and can be centrally joined about support that may he attached to a circuit board. One skilled in the art will recognize that this support may be located anywhere along the leaves. The SMA strips are then stacked between the leaves. In many embodiments, it may be preferable for the leaves to encircle the SMA strip. This can be achieved with one leaf wrapped around and pinched at the top and bottom or can be achieved with a leaf on either side of the SMA strip and joined at the top and bottom. The leaf may comprise a wide variety of materials, but for purposes of describing this invention, they will be discussed as metal leaves.

The electronic control powers the bending actuator. Once current is run, the heat generated activates the SMA material. This activation causes the SMA material to contract, bending the leaves into oblong or elliptical shapes. As the heat is conducted through the bending actuator, the leaves systematically bend causing amplified movement of the actuator. This gives the invention a multiplier effect by giving large, silent movement for small actuation.

In one setting, for example, this bending actuator may achieve a star shape through rotational movement. The SMA strips can be stacked between leaves and centrally joined about a support at one end. Once the SMA strips are activated, the leaves will bend about the support in a rotational manner and form a star shape. As long as the SMA strips are activated and contracted, this shape will be maintained.

Once the SMA strips are cooled, they will not be a contracted state and will relax. This action causes the leaves to lengthen with the SMA strips and fit back into its original stacked position. The contraction and relaxation of the SMA strips may occur many times.

In some instances, such as the star discussed above, it may be desired to attach an LED to the top portion of the joined leaves and SMA strip. This LED will become illuminated when the bending actuator is activated. This adds to the aesthetic appeal of the star for use as decoration on a Christmas tree, door, desk, table, etc.

Once skilled in the art will recognize that there are situations whereby the SMA material and leaves may be stacked as described above but instead of being centrally joined about the support, they may each be attached to a support at varying locations. This allows for a different configuration in that the leaves will bend upon SMA activation into a linear position rather then the rotational one discussed in the star for example. This setting can be appropriate for a lantern or a box as examples.

To achieve larger movement, one skilled in the art will recognize that smaller leaves and SMA strips can be stacked in between larger leaves and SMA strips forcing larger, more amplified movements of the bending actuator.

One skilled in the art will recognize that there may be arrangements whereby it is preferable to continuous strips or strands of the SMA material. This can be laced through the leaves bending each leaf into an “S” configuration. Each leaf can then be joined with other leaves to form the oblong or elliptical shape to achieve amplified linear movement. Once skilled in the art will recognize shapes other then the oblong configuration is possible.

It is recognized that the above discussion describe this bending actuator as moving in a planar fashion. However, it is possible to achieve three-dimensional movement as well.

While the above discusses the leaves and SMA strips as stacking flat, it is possible to use leaves that are already in a bent fashion. Using leaves that are bent may help achieve equal displacement to force ratios in amplifying movement. In a flat leaf situation, as displacement increases, force decreases.

While this invention has been discussed in terms of the bending actuator as a star decoration or a lantern, there are many more uses. One skilled in the art will recognize that this actuator can be applied to valves, blinds, plugs, door bolts, air pumps, toys, light stands, climbing devices, etc. This invention is able to actuate silently with very low weight and can be desirable in many settings. The rotational or linear motion created by the SMA strip contraction causes this invention to be extremely versatile.

Other advantages and aspects of the present invention will become apparent upon reading the following description of the drawings and the detailed description of a preferred embodiment of the invention.

### DETAILED DESCRIPTION OF THE DRAWINGS

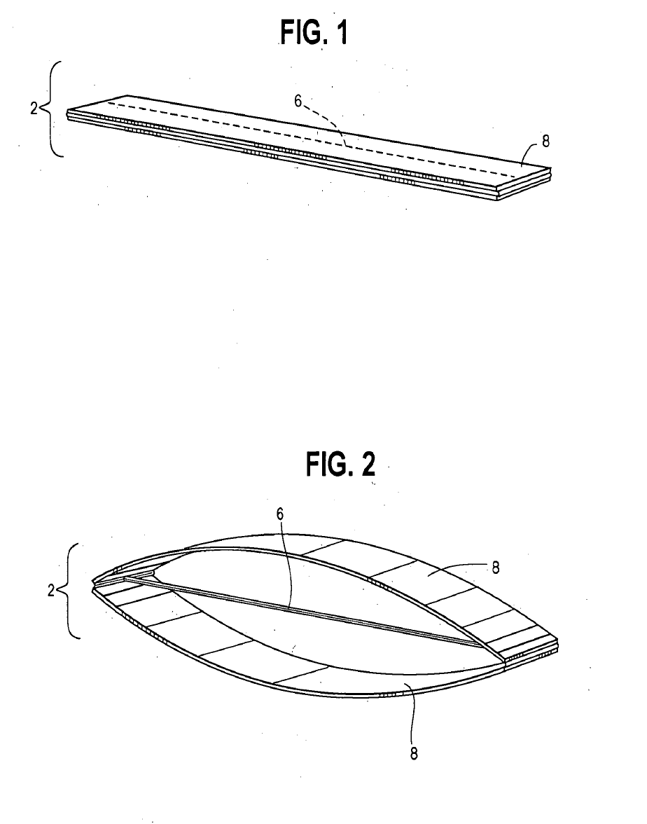

FIG. 1 depicts the stacked, bending actuator with two leaves in its inactive position.

FIG. 2 depicts the stacked, bending actuator in an active position.

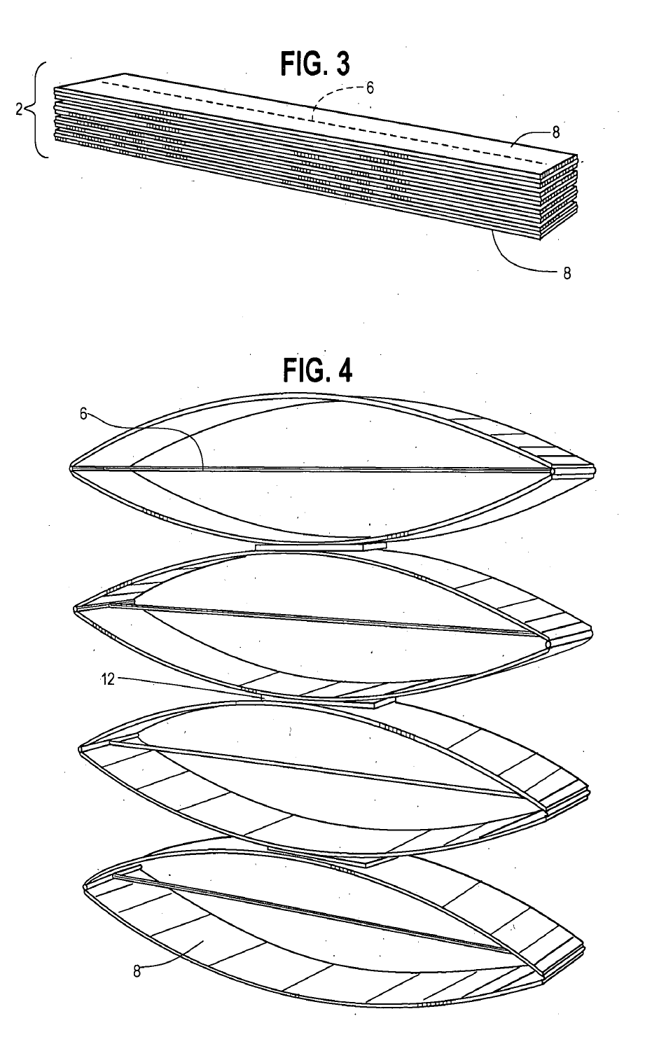

FIG. 3 depicts the stacked, bending actuator with multiple leaves in its inactive position.

FIG. 4 depicts the stacked, bending actuator with multiple leaves in its active position achieving amplified linear movement.

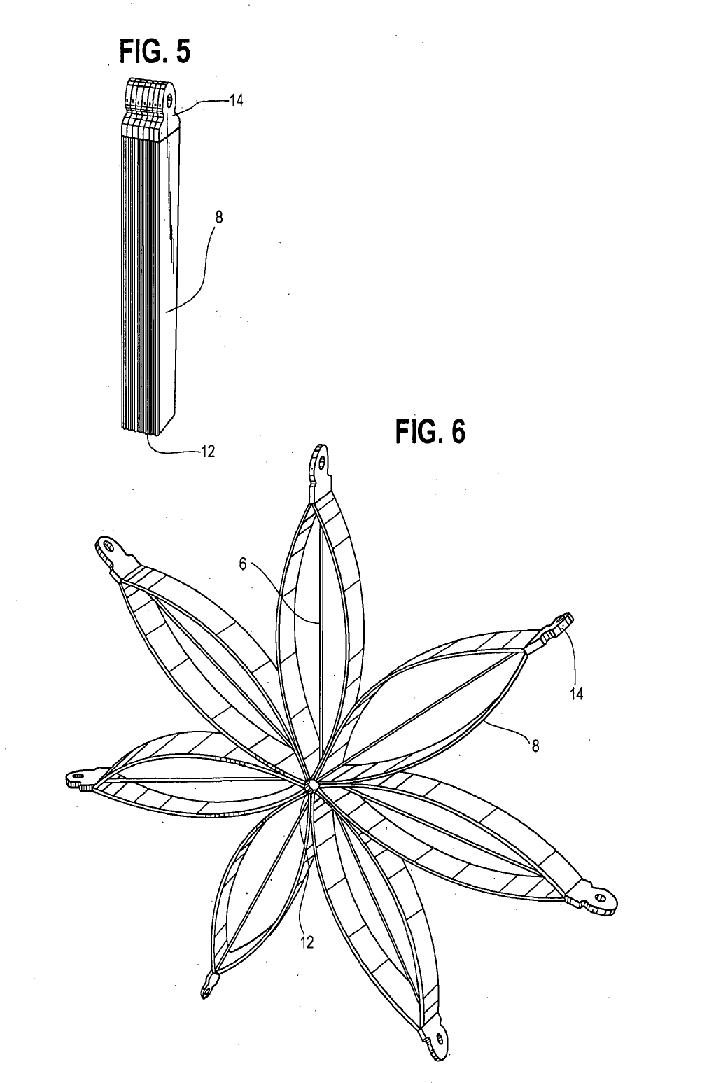

FIG. 5 depicts the stacked bending actuator with multiple leaves in an inactive position joined by a support at one end.

FIG. 6 depicts the stacked, bending actuator with multiple leaves in an active position joined by a support at one end forming a star shape.

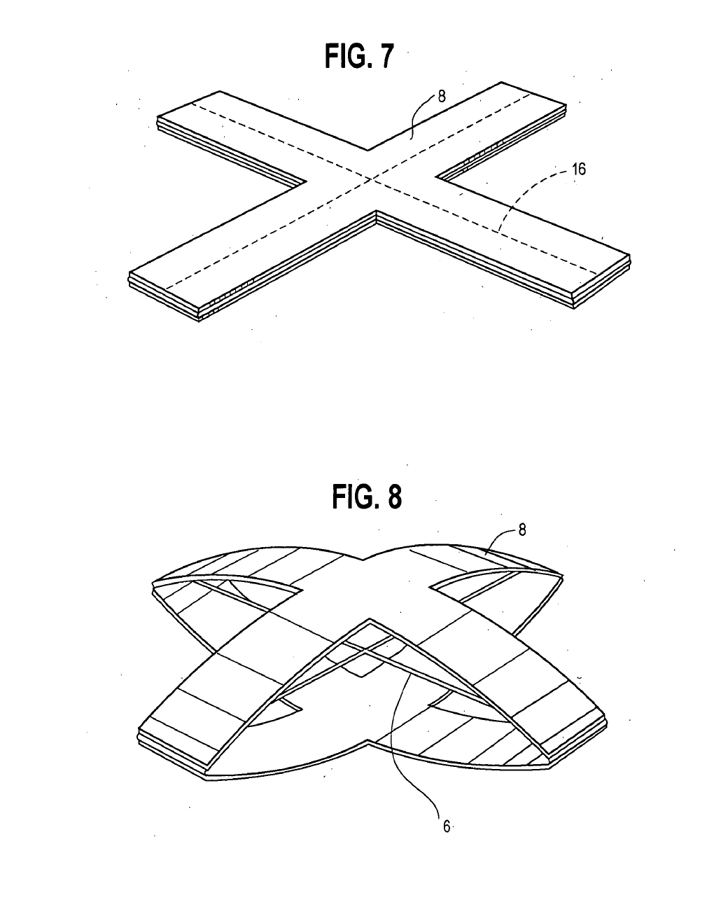

FIG. 7 depicts the stacked, bending actuator in an inactive cruciform state.

FIG. 8 depicts the stacked, bending actuator in an active cruciform state.

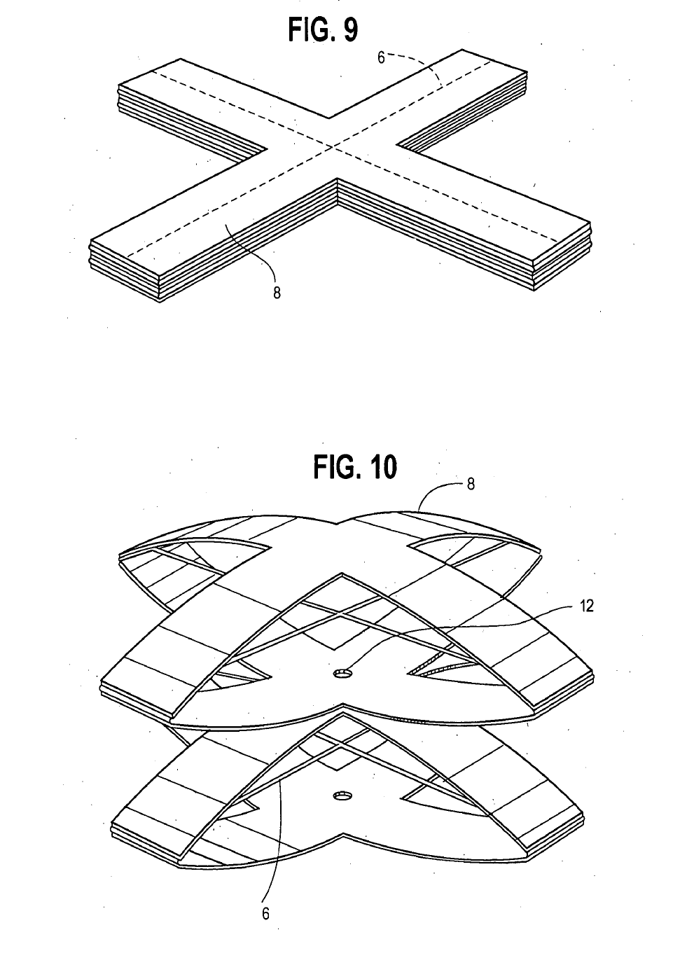

FIG. 9 depicts the stacked, bending actuator with multiple stacked leaves in an inactive cruciform state.

FIG. 10 depicts the stacked, bending actuator with multiple stacked leaves in an active cruciform state.

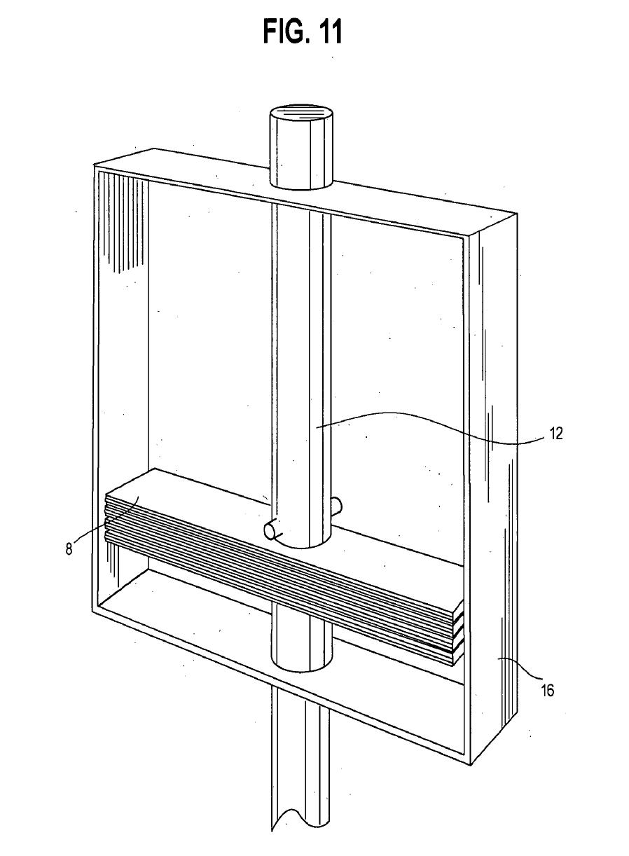

FIG. 11 depicts the stacked, bending actuator in its inactive linear form.

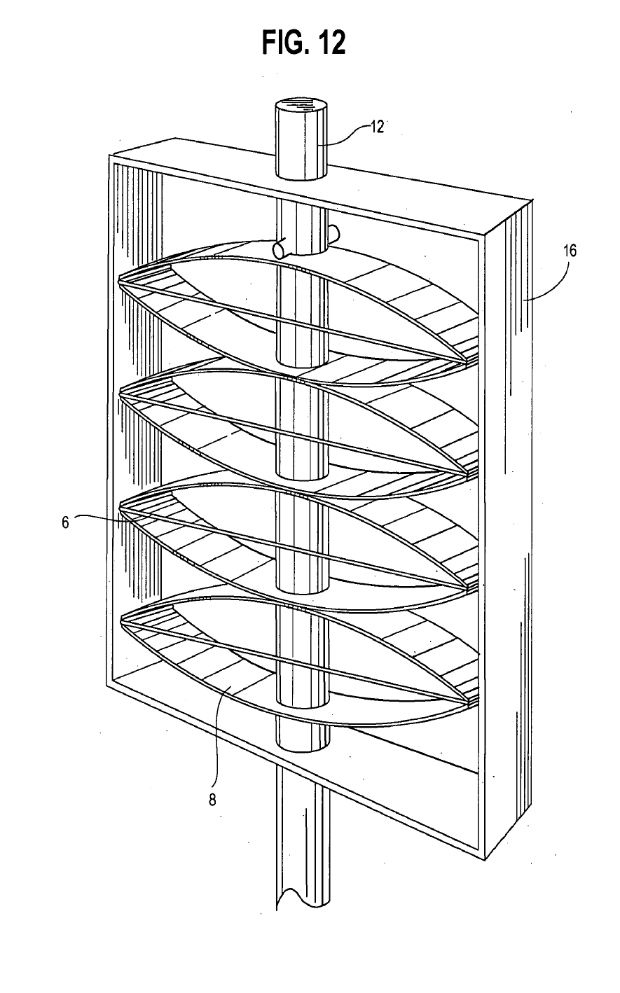

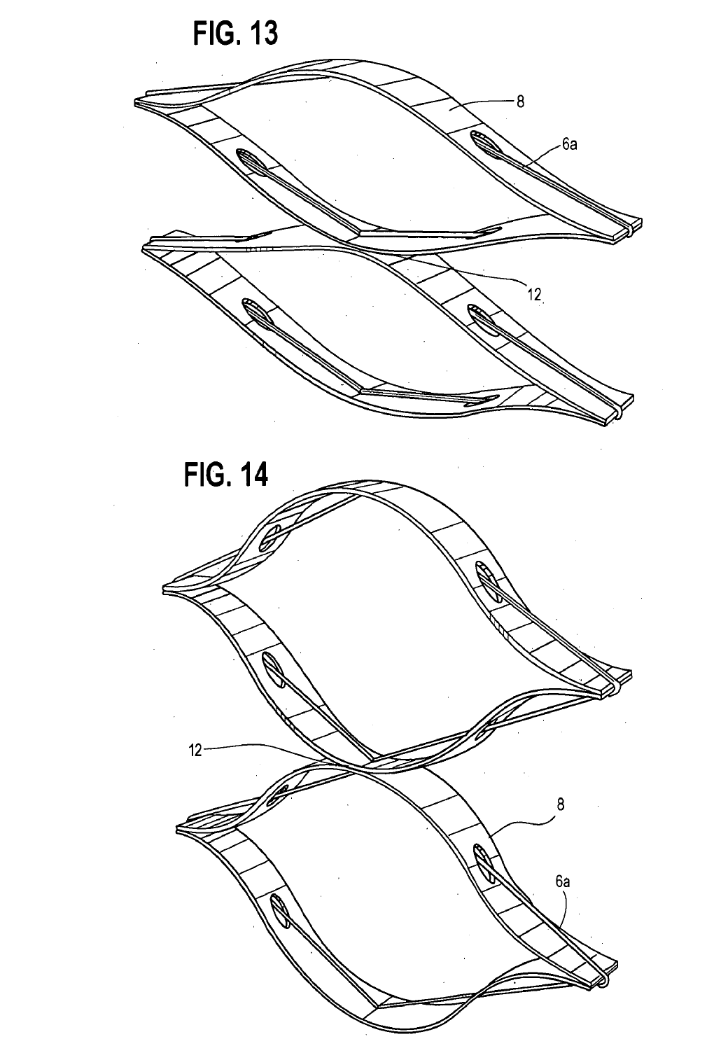

FIG. 12 details the stacked, bending actuator in its active linear form.

FIG. 13 depicts a continuous SMA element laced through the leaves comprising the actuator in its inactive state.

FIG. 14 depicts a. continuous SMA element laced through the leaves comprising the actuator in its active state.

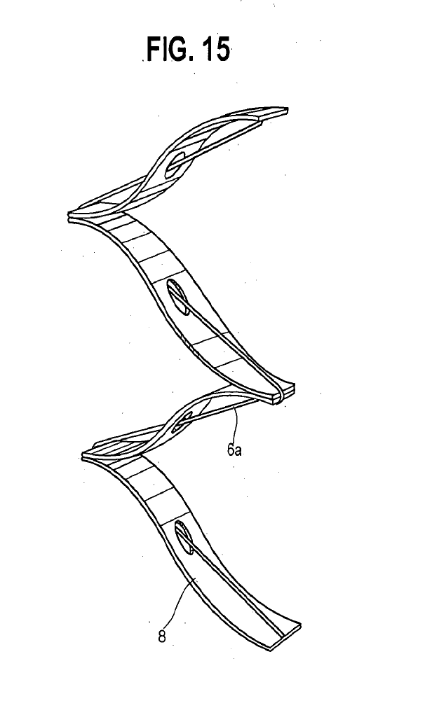

FIG. 15 depicts a continuous SMA element laced through the leaves comprising the actuator in its active state having an unbalanced linear form.

### DETAILED DESCRIPTION OF THE PREFERRED EMBODIMENT

In its preferred embodiment, this invention relates to a stacked, bending actuator 2 comprising at least two leaves 8 having bending or morphing capabilities; material adapted to contract when activated 6 attached to the leaves 8, and electronic control 10. The material adapted to contract when activated 6 is preferably shape memory alloy (SMA) material in the form of strips or wire.

The leaves 8 are stacked as seen in FIG. 1. The SMA strip or wire 6 is placed between the leaves 8. The leaves 8 are joined at both ends in a manner that hinges the leaves 8 together. When electric current (not shown) is run through the SMA wire 6 it is activated and begins to contract. As the SMA wire 6 contracts, the leaves 8 bend and morph into elliptical or oblong shapes. This is seen in FIG. 2. It is likely that many leaves 8 and many pieces of SMA wire 6 will be stacked together as seen in FIG. 3. As the SMA strips 6 are activated, movement in a linear manner is noted as seen in FIG. 4. One skilled in the art will recognize that the SMA wires 6 can be activated all at once and can be activated incrementally depending on the situation.

This invention may have another preferred embodiment whereby the stacked, bending actuator 2 achieves amplified rotational movement. In this embodiment, the leaves 8 with the SMA wire 6 stacked in between the leaves 8 are joined a support 18 at one end of the leaves 8. As the electric current runs through and activates the SMA wire 6, the leaves 8 bend into oblong shapes about the support 18 as seen in FIG. 6

FIGS. 7-10 depict the stacked, bending actuator in a cruciform shape. This configuration is another embodiment for achieving amplified linear movement.

FIGS. 11-12 depict a box situation whereby the stacked bending actuator 2 is centrally joined about a support 18 and contained within a box for controlled, amplified linear movement.

FIGS. 13-15 depict a. scenario whereby a continuous wire or strip of SMA material 6A is laced through the leaves 8. This situation results in each leaf achieving amplified movement in an “S” shape.

The invention may be described in terms of claims that can assist the skilled reader in understanding the various aspects and preferments of the invention. It will be appreciated by those skilled in the art that many modifications and variations may be made to the embodiments described herein without departing from the spirit and scope of the invention.

### INDUSTRIAL APPLICABILITY

As will be appreciated by those skilled in the various arts, this invention disclosed herein is not limited to the examples set our above and has wide application in many areas. This invention represents a significant advance in the art of bending actuators.

What is claimed is:

1. A stacked, bending actuator comprising:
at least two leaves having bending or morphing capabilities,
material adapted to contract when activated attached to said leaves; and
electronic control
wherein said leaves and said material adapted contract when activated are stacked in a desired arrangement.

2. The stacked, bending actuator as in claim 1 further comprising a circuit board.

3. The stacked, bending actuator as in claim 1 wherein said material adapted to contract when activated is an SMA strip or wire and is attached to said leaves at the top and bottom of said leaves or laced continuously through the leaves.

4. The bending actuator as in claim 3 wherein said material adapted to contract when activated is activated causing said leaves to bend in linear or rotational movement.

5. The bending actuator as in claim 4 further comprising an LED, decorative covering, or other desired decorative features.
